(19) United States
(12) Patent Application Publication
(10) Pub. No.: US 2022/0368147 A1
(43) Pub. Date: Nov. 17, 2022

(54) Power Tool

(71) Applicant: Andreas Stihl AG & Co. KG, Waiblingen (DE)

(72) Inventors: Andre VAAS, Jagstzell (DE); Michael KAISER, Waiblingen (DE); Hendrik Alexander BORNHOEFFT, Seevetal (DE); Juri LESCHENKO, Hamburg (DE)

(21) Appl. No.: 17/741,924

(22) Filed: May 11, 2022

(30) Foreign Application Priority Data
May 12, 2021 (EP) 21173688.9

(51) Int. Cl. H02J 7/00

(52) U.S. Cl. CPC H02J 7/0063; H02J 7/0013; B25F 5/00

(57) ABSTRACT

A power tool has a first electrical energy store and an operating data detection device for detecting operating data of the power tool. The operating data detection device includes an integrated circuit for wirelessly transmitting detected operating data. The power tool has a second electrical energy store, wherein the integrated circuit can be supplied from the first electrical energy store or from the second electrical energy store. The power tool has a circuit for reducing the rate of voltage rise, which circuit is designed to reduce a rate of voltage rise of a supply voltage of the integrated circuit when the supply of the integrated circuit from the second energy store is switched over to the first energy store.

### CROSS REFERENCE TO RELATED APPLICATION

This application claims priority under 35 U.S.C. § 119 from European Patent Application No. 21173688.9, filed May 12, 2021, the entire disclosure of which is herein expressly incorporated by reference.

### BACKGROUND AND SUMMARY

The invention is based on the object of providing a power tool that exhibits a high degree of operational reliability.

The power tool comprises a conventional first electrical energy store, for example in the form of what is known as a rechargeable battery pack.

The power tool also comprises an operating data detection device for detecting operating data of the power tool, for example a lifetime of the power tool and other operation-related data. The operating data detection device comprises an integrated circuit (IC) for wirelessly transmitting detected operating data to a suitable receiver. The operating data detection device also comprises a second electrical energy store, wherein the integrated circuit can be or is supplied with electrical energy either from the first electrical energy store or from the second electrical energy store.

The power tool or the operating data detection device also comprises a circuit for reducing the rate of voltage rise, which circuit is designed to reduce a rate of voltage rise of a supply voltage of the integrated circuit when the electrical supply of the integrated circuit from the second energy store is switched over to the first energy store or vice versa. The rate of voltage rise can be reduced, for example, by 5%, 10%, 50% or more. In particular, the circuit for reducing the rate of voltage rise is designed to reduce the rate of voltage rise to a value at which the integrated circuit still operates reliably.

In one embodiment, the circuit for reducing the rate of voltage rise comprises a voltage controller having an adjustable output voltage, wherein the output voltage of the voltage controller forms the supply voltage of the integrated circuit after the supply of the integrated circuit from the second energy store has switched over to the first energy store. The voltage controller can be supplied from the first energy store, that is to say can generate the output voltage thereof from a voltage of the first energy store.

In one embodiment, the voltage controller comprises a control voltage terminal, to which a control voltage is or can be applied. The circuit for reducing the rate of voltage rise also comprises a circuit for generating the control voltage, in particular in the form of a low-pass, wherein the output voltage of the voltage controller is applied to the circuit for generating the control voltage. The voltage controller adjusts a level of the output voltage thereof in such a way that the control voltage has a predetermined level, for example 1.5 V.

In one embodiment, the power tool comprises an electric motor fed from the first electrical energy store, said electric motor suitably driving a tool, for example a saw chain.

In one embodiment, the first electrical energy store is rechargeable.

In one embodiment, the second electrical energy store is non-rechargeable. For example, the second electrical energy store may be a non-rechargeable button cell.

In one embodiment, the integrated circuit is designed for wirelessly transmitting detected operating data based on a Bluetooth Low Energy (BLE) standard. As an alternative, other wireless technologies can also be used, such as, for example, RFID, WLAN, NB-IoT etc.

In one embodiment, the power tool comprises a base component, wherein the base component comprises an electrical interface for connecting the first electrical energy store. The base component may comprise, for example, a housing, in which components of the power tool are arranged.

In one embodiment, the power tool is a chainsaw, or a hedge trimmer, or a leaf blower, or a leaf vacuum, or a lawnmower, or a brush cutter.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a highly schematic block circuit diagram of a power tool according to an embodiment of the invention;

FIG. 2 is a circuit diagram of a voltage controller as a component part of a circuit for reducing the rate of voltage rise, wherein the circuit is a component part of the power tool shown in FIG. 1; and

FIG. 3 shows, by way of example, a time profile of a supply voltage of an integrated circuit of the power tool shown in FIG. 1 when the supply of the integrated circuit from a second energy store is switched over to a first energy store.

### DETAILED DESCRIPTION OF THE DRAWINGS

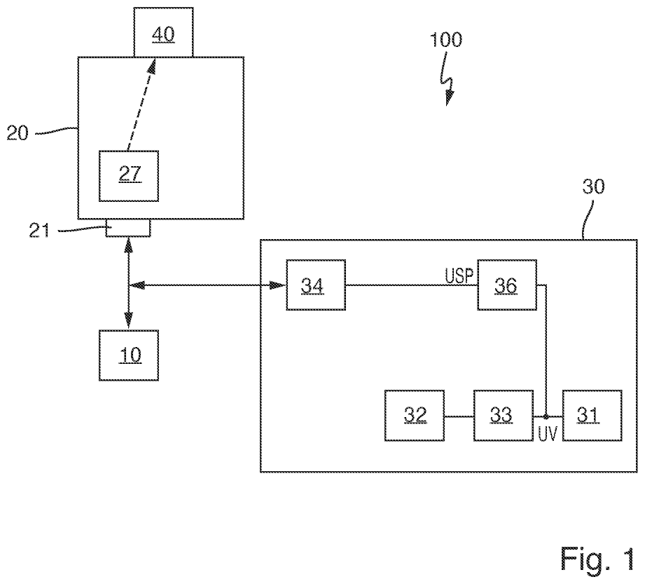

FIG. 1 highly schematically shows a block circuit diagram of a power tool 100, for example in the form of a chainsaw, or a hedge trimmer, or a leaf blower, or a leaf vacuum, or a lawnmower, or a brush cutter.

The power tool 100 comprises a base component 20, wherein the base component 20 comprises an electrical interface 21 for connecting a first rechargeable electrical energy store 10. The base component 20 comprises, for example, an electrical device housing, etc.

The first electrical energy store 10 may be a conventional rechargeable battery pack, for example.

An electric motor 27, which drives a tool 40, for example in the form of a cutting chain, and which is fed from the first electrical energy store 10, is arranged in the base component 20.

The power tool 100 also comprises an operating data detection device 30 for detecting operating data of the power tool 100.

The operating data detection device 30 comprises a conventional undervoltage protection system 34, which is fed from the first electrical energy store 10, provided this is present. The undervoltage protection system 34 outputs a feed voltage USP, which corresponds to a voltage output by the first electrical energy store 10 except for the case of an undervoltage.

The operating data detection device 30 also comprises a circuit 36 for reducing the rate of voltage rise.

The operating data detection device 30 also comprises an integrated circuit 31 for wirelessly transmitting detected operating data. The integrated circuit 31 is designed for wirelessly transmitting detected operating data based on a Bluetooth Low Energy (BLE) standard. Reference is also made in this respect to the relevant specialist literature. As an alternative, other wireless technologies can also be used, such as, for example, RFID, WLAN, NB-IoT etc.

The operating data detection device 30 also comprises a (second) electrical energy store 32 in the form of a non-rechargeable button cell and a charge reversal protection system 33, wherein the integrated circuit 31 can be supplied with electrical operating energy in principle from the first electrical energy store 10, if coupled and sufficiently charged, or from the second electrical energy store 32. It is understood that suitable decoupling circuits, which are not explicitly illustrated, can be provided to decouple the two energy stores 10 and 32.

The circuit 36 for reducing the rate of voltage rise converts a level of a voltage output by the first electrical energy store 10, that is to say a level of the feed voltage US, to a level of, for example, 3.3 V, using which subsequent components can be suitably supplied.

The circuit 36 for reducing the rate of voltage rise is designed to reduce a rate of voltage rise of a supply voltage UV of the integrated circuit 31 when the supply of the integrated circuit 31 from the second energy store 32 is switched over to the first energy store 10, for example due to a coupling or plugging of the first energy store 10. Typically, the voltage level output by the second energy store 32 is namely lower than the voltage level output by the first energy store 10 or the undervoltage protection system 34. Without the circuit 36 for reducing the rate of voltage rise, there would be the risk of a malfunction, in particular a reset, on account of the excessively high rate of rise of the supply voltage UV.

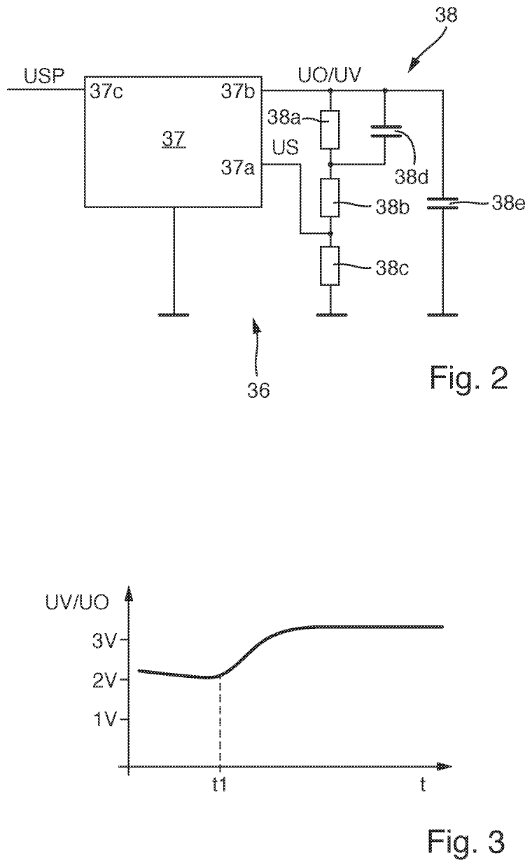

FIG. 2 shows a voltage controller 37, which is a component part of the circuit 36 for reducing the rate of voltage rise shown in FIG. 1.

The voltage controller 37 outputs an adjustable output voltage UO at its output 37b, wherein the output voltage UO generated in such a way forms the supply voltage UV of the integrated circuit 31 when the first energy store 10 is connected and charged. When the first energy store 10 is not connected or is not sufficiently charged, the supply voltage UV is generated from the second energy store 32 without involving the voltage controller 37. The voltage controller 37 is supplied with the output voltage of the first energy store 10 or the feed voltage USP at its input terminal 37c.

The voltage controller 37 comprises a control voltage terminal 37a, to which a control voltage US is applied.

The circuit 36 for reducing the rate of voltage rise also comprises a circuit 38 in the form of a low-pass for generating the control voltage US, wherein the output voltage UO of the voltage controller 37 is applied to the circuit 38 for generating the control voltage US. The circuit 38 has three resistors 38a, 38b, 38c connected in series and a capacitor 38d. The resistors 38a, 38b and 38c are looped in in series between the output 37b of the voltage controller 37 and earth. The capacitor 38d is connected in parallel with the resistor 38a. A connecting node of the resistors 38b and 38c is electrically connected to the input 37a of the voltage controller. A buffer capacitor 38e is also provided.

The voltage controller 37 adjusts a level of the output voltage UO thereof in such a way that the control voltage US has a predetermined level, for example 1.5 V.

FIG. 3 shows by way of example a voltage time profile of the supply voltage UV of the integrated circuit 31 when the supply of the integrated circuit 31 from the second energy store 32 is switched over to the first energy store 10.

Before the switchover time t1, a voltage level of the supply voltage UV is approximately 2.3 V. After the supply of the integrated circuit 31 has switched over to the first energy store 10, the voltage level of the supply voltage UV slowly increases to approximately 3.3 V, which corresponds to the level of the voltage output by the first energy store 10 or to the level of the feed voltage USP.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A power tool, comprising:
a first electrical energy store; and
an operating data detection device for detecting operating data of the power tool, the operating data detection device comprising:
an integrated circuit for wirelessly transmitting detected operating data, and
a second electrical energy store, wherein the integrated circuit can be supplied from the first electrical energy store or from the second electrical energy store, and
a circuit designed to reduce a rate of voltage rise of a supply voltage of the integrated circuit when the supply of the integrated circuit from the second energy store is switched over to the first energy store.

2. The power tool according to claim 1, wherein the circuit for reducing the rate of voltage rise comprises:
a voltage controller having an adjustable output voltage, wherein the output voltage of the voltage controller forms the supply voltage of the integrated circuit after the supply of the integrated circuit from the second energy store has switched over to the first energy store.

3. The power tool according to claim 2, wherein
the voltage controller comprises a control voltage terminal, to which a control voltage can be applied,
wherein the circuit for reducing the rate of voltage rise further comprises:
a circuit for generating the control voltage, wherein the output voltage of the voltage controller is applied to the circuit for generating the control voltage,
wherein the voltage controller adjusts a level of the output voltage thereof in such a way that the control voltage has a predetermined level.

4. The power tool according to claim 1, further comprising:
an electric motor fed from the first electrical energy store.

5. The power tool according to claim 1, wherein
the first electrical energy store is rechargeable.

6. The power tool according to claim 1, wherein
the second electrical energy store is a non-rechargeable electrical energy store.

7. The power tool according to claim 6, wherein
the non-rechargeable electrical energy store is a button cell.

8. The power tool according to claim 1, wherein
the integrated circuit is designed for wirelessly transmitting detected operating data based on a Bluetooth Low Energy standard.

9. The power tool according to claim 1, wherein
the power tool comprises a base component, and
the base component comprises an electrical interface for connecting the first electrical energy store.

10. The power tool according to claim 1, wherein
the power tool is a chainsaw, a hedge trimmer, a leaf blower, a leaf vacuum, a lawnmower, or a brush cutter.
